(19) United States
(12) Patent Application Publication
(10) Pub. No.: US 2003/0044486 A1
(43) Pub. Date: Mar. 6, 2003

(54) Hydrocolloid films for meat and poultry products

(76) Inventors: Michael F. Wargocki, Denver, CO (US); Yangsheng Wu, Parker, CO (US); Wallace H. Kunerth, Cedar Rapids, IA (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/999,085

(22) Filed: Nov. 26, 2001

Related U.S. Application Data
(60) Provisional application No. 60/253,229, filed on Nov. 27, 2000.
(60) Provisional application No. 60/311,110, filed on Aug. 9, 2001.

(51) Int. Cl. A23L 1/31

(52) U.S. Cl. 426/92

(57) ABSTRACT

Electrostatic coating compositions are provided comprising a solids content of from 25% to 75% by weight gelatin and from 75% to 25% by weight oxidized starch; or comprising a solids content of from 25% to 75% by weight alginate and from 25% to 75% by weight starch.

This application claims benefit of U.S. Provisional Patent Application Serial No. 60/253,229, filed Nov. 27, 2000 and U.S. Provisional Patent Application Serial No. 60/311,110, filed on Aug. 9, 2001.

### BACKGROUND OF THE INVENTION

The present invention relates to food coatings generally and more specifically to food coatings which can be electrostatically applied to food products by any of a variety of electrostatic coating devices.

It is well known in the art to coat food products and particularly meat products such as whole chicken, beef and pork products with biobased materials to promote preservation and water retention and prevent spoilage. Meat surfaces are generally smooth and shiny when slightly damp. Over time the meat will begin to decay even in vacuum packaging. As natural and bacterial decay occurs the color will start to change in beef from red to green and eventually to black. Also water will be released from the muscle fibers as they grow old. This results in a loss of weight or yield.

Haugaard et al., Starch. Starke 53, 189-200 (2001) reports the use of a wide variety of biobased packaging materials such as alginate, carrageenan, cellulose, gelatin, soy protein, whey protein, chitosan, camauba wax and the like as edible food coatings. Gelatin and alginate films have been reported to be particularly useful for the coating of meat products. Gelatin coatings are well-known for use on hams and the like due to their superior film forming ability. The gelatin system provides an almost completely water tight coating that is clear and will not absorb the color of the purge from the substrate it covers. It can be applied using a wet spray or electrostatically. The major drawback of gelatin coatings is that they can sometimes have a shiny plastic-like appearance. Combinations of gelatin with unmodified starch tend to be incompatible and unsuited for electrostatic coating. Of interest to the present invention is the disclosure of Wang U.S. Pat. No. 6,054,154 which discloses the electrostatic application of gelatin and maltodextrin coloring and flavoring compositions to meat substrates.

It is also known to apply aqueous solutions of sodium alginate, and aqueous starch/alginate solutions by dipping the whole meat product in a bath comprising the solution. For example, Wu et al., J. Food Science, Vol. 66, No. 3 pp. discloses the coating of precooked ground beef patties packages in edible starch-alginate based composite films. The alginate is then set by application of a calcium hydroxide solution which causes the alginate molecules to set up in a gel. While, dip baths remain useful for the application of such films there remains a desire to develop new methods of film application because of the concern that dip baths may promote the bacterial cross-contamination of meat products which pass through the bath.

Electrostatic coating devices apply a charge to the food coating powders which is applied by a grounded substrate. Electrostatic coating provides a very uniform coating of powder that can be applied as a mono- or di-layer. Electrostatic coating is a particularly preferred way of coating meat products because it eliminates the risk of biological cross-contamination caused by use of a dip or waterfall which are known for applying coatings such as alginates to meat surfaces. Moreover there is less waste of materials due to the electrostatic attraction of the charged powder to the grounded substrate.

Electrostatic coating devices such as those of Kitto Coating Technologies (Scottsdale, Ariz.) are well known in the art. According to one process known in the art a coating is fluidized by separating the powder into individual particles. The particles are then pneumatically conveyed to spray nozzles which each house an electrode that negatively charges the individual particles. The charged particles are then focused onto a target such as a food product which is grounded. The electrostatic coating process applies powders in uniform, micro-thin layers to even irregular surfaces with little or no overspray and eliminate product waste and minimize clean up. The bond created with electrostatic coating is reported to be stronger than any surface or friction attraction so that the coating become a permanent part of the product due in large part to an improved powder distribution on the product. According to one method, meat products are treated with gelatin to provide improvements in meat products including reduced purge, increased shelf life, enhanced flavor, texture and color and improvements in appearance. According to other methods a bactericide is electrostatically coated to the surface of meats in order to protect the meat from Listeria while reducing the usage of the bactericide. Despite the success in the art of electrostatic coatings there remains a desire in the art for improved compositions and methods for electrostatic coating of food, and particularly meat, products.

### SUMMARY OF THE INVENTION

The present invention is directed to improvements in food coatings generally and more specifically in improvements in food coatings which can be electrostatically applied to food products by any of a variety of commercially available electrostatic coating devices. The invention therefore provides improved electrostatic coating compositions along with methods for coating food products with those compositions and the resulting coated food products. In particular, the invention provides the ability to apply to and set films on food surfaces with a dry powder and to thereby avoid the problems inherent in hydrating and mixing starch and gum-based solutions.

According to a first aspect of the invention, it has been found that improved gelatin containing electrostatic coating compositions can be provided by the substitution of oxidized starch for a proportion of the electrostatically coated gelatin. This is surprising because gelatin and unmodified, non-oxidized starches tend to be incompatible and do not perform as well in attempts at electrostatic coating. Moreover, the gelatin/oxidized starch combination has provides a thinner coating which is characterized by an improved texture “rub.”

Specifically, the invention provides an electrostatic coating composition for food comprising a solids content of from 25% to 75% by weight gelatin and from 75% to 25% by weight oxidized starch with compositions comprising about 50% gelatin and 50% oxidized starch being particularly preferred. Gelatin for use according to this aspect of the invention may be obtained from any of a variety of sources. The oxidized starch used according to the invention is characterized by an oxidation level of from 0.5% to 5.5% (which is calculated by taking the % chlorine on a dry starch basis from a wet reaction using sodium hypochlorite as the chlorinating agent) and more preferably from 4.5% to 5.5%. Oxidized starches for use according to the invention may be obtained from any of a variety of well known sources such as corn, wheat, potato, tapioca and other starches with potato starch being particularly preferred.

The electrostatic coating composition of the invention may further comprise any of a wide variety of additional ingredients including coloring, flavoring and textural enhancing agents where there exists a desire to apply such agents to the food product. The coating composition can also include preservative agents including but not limited to known antibacterial agents such as organic acids and the like. Alternatively, antibacterial agents can be applied separately from the electrostatic coating composition.

The coating is applied to various cuts of meat in a dry powder form. An optional first step in the processing is to add a spray of up to 2.5% of an organic acid such as lactic acid to the meat surface. Similarly a seasoning rub followed by a mild mist of water may be applied to the meat's surface before coating with the powder. The surface is then evenly sprayed with the powder to the desired thickness. At this point the system is ready to be packaged in a vacuum packaging bag and evacuated. After evacuation the bag is run through a shrink tunnel such as a waterfall of 180° F. water for three-second or similar device. The surface temperature of the coating once inside the bag must reach 90° F. to set into a film.

The coating compositions of the invention can be applied to a variety of food products but are particularly useful when applied to whole muscle foods such as chicken breast, beef or pork roast or fish muscle products. While the products of the invention may be applied to the food products as various levels selected to provide different desirable properties it has been generally been found that the coating compositions can provide improved properties to the coated food products when applied at lower coating levels than ordinarily applied. Thus, preferred coating levels for various food products have been found to be as follows: 0.5 to 1.5% for beef steaks, 0.2 to 1% for beef and pork roasts, 0.5 to 1.5% for chicken breasts, and 0.2 to 1% for whole chickens.

According to an alternative aspect of the invention it has been discovered that an alginate film can be successfully applied to the surface of a food product by electrostatic coating means when it is combined with a starch. While pure aqueous solutions of sodium alginate can successfully be applied to the surface of food products in a dipping bath, attempts to apply alginate powders to food substrates by electrostatic coating means have not met with success. In particular, the films resulting from electrostatic application of pure alginate powders have been characterized by poor clarity and poor film continuity. Further, the surface texture of the resulting films is characterized as being rough with clumps. Applicants have found that combining film forming alginates with starches generally and more preferably oxidized starches provides smooth shiny films with excellent clarity and continuity.

Specifically, the invention provides an electrostatic coating composition for food comprising from 25% to 75% by weight alginate and from 75% to 25% by weight starch with compositions comprising about 50% alginate and 50% starch being particularly preferred. While modified and unmodified starches may be used oxidized, hydrolyzed or crosslinked are particularly preferred. While corn, wheat and tapioca starches can be used according to the invention, 5% oxidized potato starch is particularly preferred.

The coating compositions of the invention can be applied to a variety of food products but are particularly useful when applied to whole muscle foods such as chicken breast or fish muscle products. While the products of the invention may be applied to the food products as various levels selected to provide different desirable properties it has been generally been found that the coating compositions can provide improved properties to the coated food products when applied at lower coating levels than ordinarily applied. Thus, preferred coating levels for various food products have been found to be as follows: beef from 0.25% to 5%, pork 0.25% to 5% and chicken 0.25% to 5%. The variation in coating percentage is related to the overall size and surface area of the cut of meat. A steak will have a much higher pickup than a roast. Chicken breasts will be higher in coating percentage than a whole bird. Despite this variation the thickness of the invention's coating and its composition will remain the same throughout all the different cuts.

According to a preferred embodiment of the invention the starch/alginate films of the invention are prepared by first mixing either by hand or with a standard mixer, for example a Hobart, until the powder constituents appear to be uniform. This can be done at ambient temperatures for which room temperature appears to be ideal. The powder is then loaded into an electrostatic powder delivery gun system. If the meat surface is relatively dry it is wetted down with either water or some form of antimicrobial agent such as lactic acid solution. This wetting can be done to a meat surface that has been rubbed with various spices as well. Once wet the surface is sprayed with the powder electrostatically. Once a uniform coating is covering the entire meat surface it must be hydrated until the powder goes clear. At this point the film can be chemically set with a calcium solution. Calcium chloride is the preferred means for setting but application of other calcium sources such as calcium lactate and calcium hydroxide work as well. The film is now ready for packaging and storage. According to a preferred method it has been found that a ratio of calcium to alginate of approximately 1 unit calcium for every 10 units alginate provides optimal properties to the resulting product. According to one aspect of the invention, extra calcium is built into the system to help continue the setting of late hydrating portions of the composition.

### DETAILED DESCRIPTION

The present invention relates to the discovery that improved electrostatic coatings for food products can be produced which comprise combinations of gelatin and oxidized starch. This is surprising because gelatin and non-oxidized starches are generally incompatible based on water competition between the starch and gelatin (both are very hygroscopic) as well as possible stratification of the wet mixtures. The gelatin/oxidized starch compositions of the invention provide thinner coatings than does gelatin alone and those thinner coatings are characterized by good textural properties “rub.”

Gelatin is a known meat coating and film former which is limited in its usefulness due to its extremely glossy appearance which is not generally considered acceptable to consumers of fresh meats. The addition of starch to the gelatin matrix dulls glossy appearance making the coating much more similar to the surface of untreated raw meat. Aqueous mixtures of gelatin and starch are believed to be incompatible due to competition for water and they do not stay combined in solution. The invention uses a dry application of the film constituents that are then hydrated in place and physically set. This produces a coating that combines the superior film forming and protein adhesion of gelatin with the added protein adhesion found in cooked oxidized potato starch, provided the system has enough free water to cook the starch during the set. The gelatin/oxidized potato compositions of the invention provide thinner coatings than does gelatin alone and those thinner coatings are characterized by good textural and organoleptic properties. A superior cost advantage is also provided by the addition of starch to gelatin coatings. Modified starch cost over ten time less than gelatin so by replacing a significant portion of the gelatin matrix with starch the cost is greatly reduced.

Gelatin may be derived from bovine and porcine as well as other sources with 100 Bloom gelatin being preferred.

Oxidized starches useful for practice of the invention may be produced at low or high pH with a preferred starch being a 5% oxidized starch produced in a high pH reaction. While pregelled starches may be used cook up (ungelatinized) starches are preferred. Starches from any of a variety of plant sources including corn, wheat, tapioca and potato may be used with potato starches being particularly preferred.

The invention powder can range from 5% to 75% starch 25% to 95% gelatin. The preferred system uses a 100 Bloom gelatin commercially available from SKW Bio-System. The starch used in the system is a 5% oxidized potato starch. Oxidation was chosen due to its strong protein bonding characteristics once cooked out. Other modifications such as esterification, cross linking and thinned will work, but they do not give the added protein binding. The temperature required to set the gelatin is approximately 90-105° F. At this temperature, the starch will begin to cook out and provide added film strength and adhesion provided that there is enough water available. Potato starch cooks out into a clear paste which is one reason it is preferable to other plant based starches.

In the preparation of the electrostatic powders of the invention, it is important that the components be uniformly mixed without pockets of components. The components must also be similar in size to flow through the electrostatic system properly. Other materials, such as seasonings and dry antimicrobials, may be incorporated into the powder assuming they follow the first two conditions. A preferred antimicrobial for use in conjunction with this system is a 2% lactic acid solution. But most any organic acid or antimicrobial spray will work in the invention.

As a further aspect of the invention it has been discovered that the combination of starch with film forming alginates provides improved properties when used to electrostatically coat food products generally and meats in particular when compared to alginate coatings alone. Specifically, it has been found that the starch/alginate compositions of the invention are characterized by greater strength than alginate films alone when evaluated by measures such as tension and flex experiments. In addition, the starch alginate compositions are characterized by better powder flow properties and faster hydration periods than do compositions comprising of alginate alone.

The electrostatic powder composition of the invention can range from 5% to 75% starch and 25% to 95% alginate with 50% alginate and 50% starch being preferred. The preferred alginate is a high viscosity alginate commercially available under the name Keltone HV from ISP alginates. Only alginates which can be set into a film, such as high G block alginates, may be used with high viscosity alginates providing the best films. Low viscosity alginates are available but do not provide major benefits despite their higher cost. Other hydrocolloids such as LM Pectin are capable of forming similar films but do not provide adequate strength. Most starches from various sources can be used in the formation of the filler. Potato starch was found to produce the best films due to its superior clarity upon cook and water absorption properties. Highly oxidized potato starches are preferred for use according to the invention due to the added benefits of adhesion that it provides after cooking. Other modification such as hydrolyzed, cross-linked and substituted will form strong films but do not have the additional protein binding abilities.

According to one method, starch is modified using sodium hypochlorite as the oxidizing agent and is reacted over a 4 hour time period until the reaction is deemed to be at completion by monitoring the rate of caustic addition. The starting material for the reaction was native potato starch recovered from a potato processor's potato cutting line. A preferred oxidized potato starch (Penford Food Ingredients) is commercially available under the name of PenCook 10. Experiments with the addition of calcium hydroxide and calcium lactate mixed in to the starch wet and dry before combination with the alginate provided strong films. The calcium available from the starch was not enough to set all of the alginate alone but seems to provide continuing chemical setting to the late hydrating alginate particles. In the preparation of the electrostatic powders of the invention, it is important that the components be uniformly mixed without pockets of either component. The components must also be of similar particle size to flow through the electrostatic system properly. Other materials, such as seasonings and dry antimicrobials, may be incorporated into the powder assuming they follow the first two conditions. A preferred antimicrobial for use with this system is a 2% lactic acid solution although most any organic acid or antimicrobial spray will work in the invention. Other organic acids useful for practice of the invention include citric acid and acetic acid. Other antimicrobials include NIS which can be applied in powder form.

As a further aspect of the invention it has been discovered that the combination of starch with alginate provides films with greater strength than alginate films alone when evaluated by measures such as torsion bending experiments. In addition, the starch/alginate compositions are characterized by better flow properties and faster hydration properties than compositions comprising alginate alone. Preferred sources of alginate for practice of the invention are those seaweed extracts which are high in G-block material.

### EXAMPLE 1

According to this example, an electrostatic coating composition comprising oxidized (5%) potato starch was used to coat beef and pork roasts. Specifically, an oxidized (5%) potato starch was prepared through a wet reaction using sodium hypochlorite at 5% Cl₂ to dry weight based on starch with native potato starch PenCook 10 (Penford Food Ingredients).

Beef and pork roasts were placed on polyfluoroethylene (Teflon®) trays and both sides were moistened with a 2% lactic acid solution. One hundred grams of the oxidized starch powder was poured into a hopper from which the powder was fed into an electrostatic powder delivery gun system (Kitto Coating Technologies Pilot II System, Scottsdale, Ariz.) set at a voltage of 6 KV, with a negatively charged gun and with a spray rate of I gram per second. The roasts were sprayed with even coatings of powder over their surfaces and the roasts were flipped from one tray to another in order to apply an even coating of powder over the surfaces. In general, 3 to 8 grams of powder were used to coat each roast depending upon their size.

Because the surface area of a roast or other food product is not proportional to its weight, the percentage pickup of a coating (i.e., the weight of coating for the weight of coated product) is not necessarily an accurate measure of coating levels. Thus, a 2 pound beef roast or whole rotisserie chicken will be characterized by a coating pickup ranging from 0.2 to 0.5% while a steak or a chicken breast will be in the 0.8% to 1.5% pickup range. A more useful measure of coating therefor is that of grams of coating per square centimeter of surface area. Preferred coating levels for the meat products of the invention are thus approximately 0.01 grams coating per square centimeter (cm²) of surface. Thus, a steak with a surface area of 273 cm² and a weight of 245 grams may have up to 3 grams of coating applied to it (1.2% pickup and 0.011 gm/cm²) while a roast with a surface area of 450 cm² may have up to 5 grams of coating applied to it (1.0% pickup but 0.011 gm/cm²). After application of the starch coating a water mist was applied to the surface to hydrate the powder until it became clear.

Whole chickens were injected with a standard brine of salt, water and phosphate using a Mepsco BI-140 injector with 150 needles. The whole chickens were weighed before and after injection and their weight was increased by 15% by pumping the bine into them. The chickens were hung from a bacon rack, coated with water and then electrostatically coated as described above with even coatings of the oxidized starch applied to all surfaces. A water mist was then applied to the surface until it became clear.

The coated roasts and whole chickens were then evaluated according to the following procedure to determine their “yield” which is reported in Table 1 below. Thus, the percent yield was calculated by taking the final end of storage substrate weight and dividing it by either the initial pumped weight before storage (stored to pumped) or by taking the final end of storage substrate weight and dividing it by the initial raw before pump or treatment weight (stored to raw).

The yield values for the coated beef roasts was determined as follows. The coated roast was placed in a vacuum bag and sealed under vacuum. After 21 days the meat was removed from the bag and yields were determined. Percent yield for stored to “raw” or “green” was calculated by taking the meat weight after 21 days and dividing that by the raw weight of the meat before coating. Percent yield for stored to coated is calculated from the final meat weight divided by the original weight after coating of the piece of meat. The results in the table for the uncoated control.

The film texture was evaluated by a subjective organoleptic test and reported in Table 1 below. “Smooth” evaluations came from rubbing a finger across the surface to tell for any bumps caused by the coating.

### EXAMPLE 2

According to this example, an electrostatic coating composition comprising 25% by weight alginate and 75% by weight of an oxidized (5%) potato starch was prepared. Specifically, a 5% oxidized potato starch was prepared through a wet reaction using sodium hypochlorite at 5% Cl₂ to dry weight based on starch with native potato starch (PenCook 10, Penford Food Ingredients). The oxidized potato starch was blended with a high viscosity alginate (Keltone HV, ISP Alginate) either by hand or with a standard mixer at room temperature until the powder constituents were uniform.

The resulting powder was then applied to filter paper substrates by the electrostatic powder delivery gun system according to the method of Example 1. Specifically, a Whatman 110 mm #4 filter paper was sprayed with a 2% lactic acid solution and then coated with the oxidized starch/alginate film at a coating level of about 0.015 gm/cm² with a goal of the coating to be a uniform thickness for all the tests. The filter paper was then sprayed with water until the surface became clear and was allowed to sit for 15 seconds. A 5% calcium chloride (CaCl₂) solution was then applied by spraying onto the filter paper to “set” the alginate film. The resulting film was then removed from the filter paper and fastened to a plastic cylinder. A Texture Analysis TA-XT2 with a 5 mm probe was used to measure the bending strength of the film. The probe stretches the film and measures the resistance force over an 8 mm long path. The peak force was then determined from the resulting curve and is reported on Table 1 below.

The tensile strength of the alginate based film was determined by removal of the film from the filter paper. A Texture Analysis TA-XT2 fitted with a set of tensile clamps was used to measure the tensile strength of the film. The clamps stretch the film and measure the force necessary to rip the film. The peak force was then determined from the resulting curve and recorded on Table 1. The protein binding potential was reported according to the following scale. 100% gelatin would be a 10; while 100% of an oxidized starch (5%) would be a 9; 100% of a dextrin would be an 8; and 100% of an oxidized starch (1%) would be a 7. 100% of an HV alginate would be a 6; and 100% of an LV alginate or of a 100% LM Pectin would be a 3 and 100% of other starches would be a 0. The clarity, continuity and texture of the film on the filter paper were also evaluated and are reported on Table 1.

### EXAMPLE 3

According to this example, an electrostatic coating composition comprising 50% by weight high viscosity (HV) alginate and 50% by weight of an oxidized (1%) potato starch (PenCling 208, Penford Corporation) was prepared according to the method of Example 2. The coating composition was applied to filter paper and evaluated according to the methods of Example 2. The results of those tests are reported in Table 1 below.

### EXAMPLE 4

According to this example, an electrostatic coating composition comprising 35% by weight high viscosity (HV) alginate and 65% by weight of an oxidized (1%) potato starch (PenCling 208, Penford Corporation) was prepared according to the method of Example 2. The coating composition was applied to filter paper according to the method of Example 2 and to beef roasts according to the method of Example 1 but further including the step of “setting” the alginate coating by application of a 5% calcium chloride (CaCl₂) solution. The films and coated meat products were then evaluated according to the methods of Examples 1 and 2 with the results reported on Table 1 below.

### EXAMPLE 5

According to this example, an electrostatic coating composition comprising 50% high viscosity (HV) alginate and 50% by weight of an acid hydrolyzed potato starch fortified with 5% calcium lactate was produced according to the method of Example 2. The acid hydrolyzed potato starch was fortified with 5% calcium lactate by dry blending the two ingredients at a 5% by dry starch weight basis. The coating composition was applied to filter paper and evaluated according to the methods of Example 2 with the results reported in Table 1 below.

### EXAMPLE 6

According to this example, an electrostatic coating composition comprising 50% by weight high viscosity (HV) alginate and 50% by weight of an oxidized (1%) potato starch (PenCling 208, Penford Corporation) was prepared according to the method of Example 2. The coating composition was applied to filter paper and evaluated according to the method of Example 2 with the results of those tests reported in Table 1 below.

### EXAMPLE 7

According to this example, an electrostatic coating composition comprising 50% by weight high viscosity alginate and 50% of a crosslinked (990 ppm dry starch basis crosslinked using POCl₃ (phosphorus oxychloride)) potato starch (PenBind 196) was prepared according to the method of example 2. The coating composition was applied to filter paper and evaluated according to the method of Example 2 with the results of those tests reported in Table 1 below.

### EXAMPLE 8

According to this example, an electrostatic coating composition comprising 100% high viscosity alginate was prepared according to the method of example 2. The coating composition was applied to filter paper according to the method of Example 2 and to beef and pork roasts according to the method of Example 4. The films and coated meat products were evaluated according to the methods of Examples 1 and 2 with the results reported on Table 1 below.

### EXAMPLE 9

According to this example, an electrostatic coating composition comprising 50% high viscosity alginate and 50% native potato starch (PenCook 10) was prepared according to the method of example 2. The coating composition was applied to filter paper and evaluated according to the method of Example 2 with the results of those tests reported in Table 1 below.

### EXAMPLE 10

According to this example, an electrostatic coating composition comprising 50% high viscosity alginate and 50% oxidized (5%) potato starch was prepared according to the method of example 2. The coating composition was applied to filter paper according to the method of Example 2 and to beef and pork roasts and whole rotisserie chicken according to the methods of Examples 1 and 4. The films and coated meat products were evaluated according to the methods of Examples 1 and 2 with the results reported on Table 1 below.

### EXAMPLE 11

According to this example, an electrostatic coating composition comprising 50% high viscosity alginate and 50% potato dextrin was prepared according to the method of example 2. The coating composition was applied to filter paper and evaluated according to the method of Example 2 with the results of those tests reported in Table 1 below.

### EXAMPLE 12

According to this example, an electrostatic coating composition comprising 50% high viscosity alginate and 50% Acid hydrolyzed (thinned with 0.4 N HCl to the correct Brabender viscosity of 600-1300 BU) potato starch (PenBind 800, Penford Food Ingredients) was prepared according to the method of Example 2. The coating composition was applied to filter paper and evaluated according to the method of Example 2 with the results of those tests reported in Table 1 below.

### EXAMPLE 13

According to this example, an electrostatic coating composition comprising 50% high viscosity alginate and 50% acid hydrolyzed potato starch fortified with 5% Ca(OH)₂ was prepared according to the method of example 2. The acid hydrolyzed potato starch of example 12 fortified with 5% Ca(OH)₂ was prepared by dry blending the two ingredients at a 5% by dry starch weight basis. The coating composition was applied to filter paper and evaluated according to the method of Example 2 with the results of those tests reported in Table I below.

### EXAMPLE 14

According to this example, an electrostatic coating composition comprising 100% of a low viscosity (LV) alginate (Keltone LV, ISP Alginate). was prepared according to the method of Example 2. The coating composition was applied to filter paper on which clarity, continuity and surface texture of film were evaluated according to the method of Example 2 and to beef roasts according to the methods of Example 4. In cases where results were reported for food products the surface characteristics were also determined on the food surface as well. The films and coated meat products were evaluated according to the method of Example 2 with the results reported on Table 1 below.

### EXAMPLE 15

According to this example, an electrostatic coating composition comprising non-purified food-grade high viscosity alginate was prepared according to the method of example 2. The coating composition was applied to filter paper and evaluated according to the method of Example 2 with the results of those tests reported in Table 1 below.

### EXAMPLE 16

According to this example, an electrostatic coating composition comprising 35% low viscosity alginate and 65% oxidized (5%) potato starch was prepared according to the method of example 2. The coating composition was applied to filter paper according to the method of Example 2 and to beef roasts according to the methods of Example 4. The films and coated meat products were evaluated according to the methods of Examples 1 and 2 with the results reported on Table 1 below.

### EXAMPLE 17

According to this example, an electrostatic coating composition comprising 50% low viscosity alginate and 50% oxidized (5%) potato starch was prepared according to the method of example 2. The coating composition was applied to filter paper according to the method of Example 2 and to beef roasts according to the methods of Example 4. The films and coated meat products were evaluated according to the methods of Examples 1 and 2 with the results reported on Table 1 below.

### EXAMPLE 18

According to this example, an electrostatic coating composition comprising 75% high viscosity alginate and 25% oxidized (5%) potato starch was prepared according to the method of example 2. The coating composition was applied to filter paper according to the met hod of Example 2. The coating composition was applied to filter paper and evaluated according to the method of Example 2 with the results of those tests reported in Table 1 below.

### EXAMPLE 19

According to this example, an electrostatic powder was prepared comprising 100% gelatin (SKW Biosystems 225A 100 Bloom gelatin). Specifically, the gelatin was poured into a hopper for the e-stat gun system and applied to Whatman filter paper discs that had been moistened with five sprays of water. The paper was then electrostatically coated with the gelatin powder sprayed evenly using an electrostatic powder delivery gun system (Kitto Coating Technologies Pilot II System, Scottsdale, Ariz.) set at a voltage of 6 KV (with a negatively charged gun) and with a spray rate of 1 gram per second. The coated filter papers were then sprayed with water for additional hydration. The filter papers were then vacuumed packaged and placed in water at 180° F. for three seconds to simulate a shrink tunnel. The papers were then removed from the package and were evaluated for surface characteristics according to the methods of Example 2.

Beef and pork roasts were placed on polyfluoroethylene (Teflon) trays and both sides were moistened with a 2% lactic acid solution. One hundred grams of the powder was poured into a hopper from which the powder was fed into an electrostatic powder delivery gun system (Kitto Coating Technologies Pilot II System, Scottsdale, Ariz.) set at a voltage of 6 KV, with a negatively charged gun, and with a spray rate of 1 gram per second. The roasts were sprayed with even coatings of powder over their surfaces and the roasts were flipped from one tray to another in order to apply an even coating of powder over the surfaces. After application of the starch coating a water mist was applied to the surface to hydrate the powder until it became clear. The products were then evaluated according to the method of Example 2 with the results of those evaluations reported in Table 1 below.

### EXAMPLE 20

According to this example, an electrostatic coating composition comprising 75% gelatin and 25% of the oxidized (5%) starch of example 2 was prepared according to the method of example 19. The composition was applied to filter paper according to the method of Example 19 and evaluated according to the method of Example 2 with the results of those evaluations reported in Table 1.

### EXAMPLE 21

According to this example, an electrostatic coating composition comprising 50% gelatin and 50% of an oxidized (5%) potato starch was prepared according to the method of Example 19. The coating composition was applied to filter paper, beef and pork roasts according to the method of Example 19 and whole rotisserie chickens according to the methods of Example 1 and evaluated according to the method of Example 2 with the results of those evaluations reported in Table 1 below.

### EXAMPLE 22

According to this example, an electrostatic coating composition comprising 40% gelatin and 60% of an oxidized (5%) potato starch was prepared according to the method of Example 19. The composition was applied to filter paper according to the method of Example 19 and evaluated according to the method of Example 2 with the results of those evaluations reported in Table 1.

### EXAMPLE 23

According to this example, an electrostatic coating composition comprising 100% of a pectin (Tic Pretested Pectin LM32) was applied by elecrostatic coater according to the method of Example 19. The filter paper was then evaluated according to the method of Example 2 with the results of those evaluations reported in Table 1.

### EXAMPLE 24

According to this example, an electrostatic coating composition comprising 50% pectin (Tic Pretested Pectin LM32) and 50% oxidized (5%) potato starch was prepared by the method of Example 23 and applied to filter paper according to the method of Example 23. The filter paper was then evaluated according to the method of Example 2 with the results of those evaluations reported in Table 1.

Review of the results reported in Table 1 show that the overall best performing system is that of Example 22 comprising a formulation of 40% gelatin and 60% oxidized (5%) potato starch, which is slightly better than that of Example No. 21 comprising a formulation of 50% gelatin and 50% oxidized (5%) potato starch. The synergistic combination of gelatin and an oxidized (5%) starch gives performance comparable to the industry standard (100% gelatin) shown in Example 19 and is very cost competitive. This system has great continuity, is perfectly clear and has the least glossy appearance of the gelatin compositions.

TABLE 1

| | | | | | | | Protein | Beef | |
|---|---|---|---|---|---|---|---|---|---|
| | | | | | | | of | Roasts | % Yield |
| | | Average | Average | | | Surface | binding | % Yield | (Stored |
| | | force to | tension | Claity of | Continuity | Texture | potential | (stored | to |
| # | Sample name | bend (g) | force (g) | Film | of Film | of Film | # | to raw) | Coated) |
| 1 | Control (uncoated and/or | 0.0 | 0.0 | — | — | smooth | — | 97.8 | — |
| | coated with only 5% | | | | | and shiny | | | |
| | Oxidized starch) | | | | | | | | |
| 2 | HV Alginate + 5% | 21.5 | 45.7 | Clear | Average | smooth | 5 | * | * |
| | Oxidized Potato Starch | | | | | | | | |
| | (25/75) | | | | | | | | |
| 3 | HV Alginate + 1% | 24.8 | 166.1 | Slightly | Poor | smooth | 6 | * | * |
| | Oxidized Pre-gel Potato | | | Opaque | | and dull | | | |
| | Starch (50/50) | | | | | | | | |
| 4 | HV Alginate + 1% | 28.9 | 101.9 | Clear | Average | smooth | 7 | 100.1 | 98 |
| | Oxidized Potato Starch | | | | | and | | | |
| | (35/65) | | | | | slightly | | | |
| | | | | | | shiny | | | |
| 5 | HV Alginate + (Acid | 37.2 | 70.2 | Not | Poor | rough and | 6 | * | * |
| | Hydrolyzed Potato Starch | | | Acceptable | | dull | | | |
| | fortified with 5% calcium | | | | | | | | |
| | lactate) (50/50) | | | | | | | | |
| 6 | HV Alginate + 1% | 39.2 | 114.6 | Slightly | Good | smooth | 7 | * | * |
| | Oxidized Potato Starch | | | Opaque | | and shiny | | | |
| | (50/50) | | | | | | | | |
| 7 | HV Alginate + Crosslinked | 43.9 | 133.8 | Slightly | Good | smooth | 5 | * | * |
| | Potato Starch (50/50) | | | Opaque | | and shiny | | | |
| 8 | HV Alginate (100) | 44.1 | 109.3 | Not | Poor | rough | 5 | 100.6 | 98.4 |
| | | | | Acceptable | | w/clumps | | | |
| 9 | HV Alginate + Native | 46.0 | 92.0 | Very | Good | smooth | 6 | * | * |
| | Potato Starch (50/50) | | | Slightly | | and shiny | | | |
| | | | | Opaque | | | | | |
| 10 | HV Alginate + 5% | 46.8 | 140.3 | Very | Excellent | smooth | 9 | 100.8 | 98.5 |
| | Oxidized Potato Starch | | | Slightly | | and shiny | | | |
| | (50/50) | | | Opaque | | | | | |
| 11 | HV Alginate + Potato | 51.3 | 127.7 | Not | Good | smooth | 6 | * | * |
| | Dextrin (50/50) | | | Acceptable | | and dull | | | |
| 12 | HV Alginate + Acid | 52.0 | 147.3 | Slightly | Good | smooth | 5 | * | * |
| | Hydrolyzed Potato Starch | | | Opaque | | and shiny | | | |
| | (50/50) | | | | | | | | |
| 13 | HV Alginate + Acid | 58.8 | 217.3 | Not | Poor | very | 3 | * | * |
| | Hydrolyzed Potato Starch | | | Acceptable | | rough and | | | |
| | fortified with 5% Ca(OH2) | | | | | dull | | | |
| | (50/50) | | | | | | | | |
| 14 | LV Alginate | * | * | Not | Average | smooth | 3 | 100.5 | 98.1 |
| | | | | Acceptable | | w/clumps | | | |
| 15 | HV Alginate (non-purified) | * | * | Not | Bad | very | 1 | * | * |
| | | | | Acceptable | | rough | | | |
| | | | | | | w/clumps | | | |
| 16 | LV Alginate + 5% Oxidized | * | * | Clear | Average | smooth | 4 | 100 | 97.6 |
| | Potato Starch (35/65) | | | | | and | | | |
| | | | | | | slightly | | | |
| | | | | | | shiny | | | |
| 17 | LV Alginate + 5% Oxidized | * | * | Not | Good | smooth | 4 | 101.4 | 97.7 |
| | Potato Starch (50/50) | | | Acceptable | | and shiny | | | |
| 18 | HV Alginate + 5% | * | * | Not | Good | smooth | 4 | * | * |
| | Oxidized Potato Starch | | | Acceptable | | and too | | | |
| | (75/25) | | | | | shiny | | | |
| 19 | Gelatin (100) | * | * | Clear | Great | smooth | 10 | 100.5 | 99.6 |
| | | | | | | and too | | | |
| | | | | | | glossy | | | |
| 20 | Gelatin + 5% Oxidized | * | * | Clear | Great | smooth | 10 | * | * |
| | Potato Starch (75/25) | | | | | and too | | | |
| | | | | | | glossy | | | |
| 21 | Gelatin + 5% Oxidized | * | * | Clear | Great | smooth | 10 | 99.9 | 99.2 |
| | Potato Starch (50/50) | | | | | and | | | |
| | | | | | | somewhat | | | |
| | | | | | | shiny | | | |
| 22 | Gelatin + 5% Oxidized | * | * | Clear | Great | smooth | 10 | * | * |
| | Potato Starch (40/60) | | | | | and very | | | |
| | | | | | | slightly | | | |
| | | | | | | shiny | | | |
| 23 | LM Pectin (100) | * | * | Slightly | Average | smooth | 3 | * | * |
| | | | | Opaque | | w/clumps | | | |
| 24 | LM Pectin + 5% Oxidized | * | * | Clear | Average | smooth | 3 | * | * |
| | Potato Starch (50/50) | | | | | w/clumps | | | |

| | | Pork | | Whole | |
|---|---|---|---|---|---|
| | | Roast | Yield | Chicken | % Yield |
| | | % Yield | (Stored | % Yield | (Stored |
| | | Stored | to | (Stored | to |
| # | Sample name | to Raw) | Coated) | to Raw) | Purified) |
| 1 | Control (uncoated and/or | 97.3 | — | 105.8 | 92.6 |
| | coated with only 5% | | | | |
| | Oxidized starch) | | | | |
| 2 | HV Alginate + 5% | * | * | * | * |
| | Oxidized Potato Starch | | | | |
| | (25/75) | | | | |
| 3 | HV Alginate + 1% | * | * | * | * |
| | Oxidized Pre-gel Potato | | | | |
| | Starch (50/50) | | | | |
| 4 | HV Alginate + 1% | * | * | * | * |
| | Oxidized Potato Starch | | | | |
| | (35/65) | | | | |
| 5 | HV Alginate + (Acid | * | * | * | * |
| | Hydrolyzed Potato Starch | | | | |
| | fortified with 5% calcium | | | | |
| | lactate) (50/50) | | | | |
| 6 | HV Alginate + 1% | * | * | * | * |
| | Oxidized Potato Starch | | | | |
| | (50/50) | | | | |
| 7 | HV Alginate + Crosslinked | * | * | * | * |
| | Potato Starch (50/50) | | | | |
| 8 | HV Alginate (100) | 99 | 96.3 | * | * |
| 9 | HV Alginate + Native | * | * | * | * |
| | Potato Starch (50/50) | | | | |
| 10 | HV Alginate + 5% | 99.3 | 97.7 | 110.0 | 96.3 |
| | Oxidized Potato Starch | | | | |
| | (50/50) | | | | |
| 11 | HV Alginate + Potato | * | * | * | * |
| | Dextrin (50/50) | | | | |
| 12 | HV Alginate + Acid | * | * | * | * |
| | Hydrolyzed Potato Starch | | | | |
| | (50/50) | | | | |
| 13 | HV Alginate + Acid | * | * | * | * |
| | Hydrolyzed Potato Starch | | | | |
| | fortified with 5% Ca(OH2) | | | | |
| | (50/50) | | | | |
| 14 | LV Alginate | * | * | * | * |
| 15 | HV Alginate (non-purified) | * | * | * | * |
| 16 | LV Alginate + 5% Oxidized | * | * | * | * |
| | Potato Starch (35/65) | | | | |
| 17 | LV Alginate + 5% Oxidized | * | * | * | * |
| | Potato Starch (50/50) | | | | |
| 18 | HV Alginate + 5% | * | * | * | * |
| | Oxidized Potato Starch | | | | |
| | (75/25) | | | | |
| 19 | Gelatin (100) | 99.7 | 98.5 | * | * |
| 20 | Gelatin + 5% Oxidized | * | * | * | * |
| | Potato Starch (75/25) | | | | |
| 21 | Gelatin + 5% Oxidized | 99.1 | 98 | 111.4 | 97.5 |
| | Potato Starch (50/50) | | | | |
| 22 | Gelatin + 5% Oxidized | * | * | * | * |
| | Potato Starch (40/60) | | | | |
| 23 | LM Pectin (100) | * | * | * | * |
| 24 | LM Pectin + 5% Oxidized | * | * | * | * |
| | Potato Starch (50/50) | | | | |

*denotes that the data was not collected for those variables because they were previously removed from contention
—denotes that the test is not applicable to this particular variable
#denotes that this measurement is by adhesion of the film to the meat surface before and after cooking. It is a measurement of the ability to remove the film from the meat surface while hot.
**denotes data gathered from whole chickens pumped to 15% by weight

The best performing starch/alginate system was that comprising 50% high viscosity alginate and 50% of an oxidized (5%) potato starch (Example 10) which exhibited excellent clarity, continuity and texture. The protein binding of this system is only surpassed by that of the gelatin systems due to the highly oxidized potato starch. The film bending and tension strengths are very high, but not too high. While the combination of alginate with an acid hydrolyzed potato starch fortified with calcium hydroxide (Example 13) provided the strongest results in the bending and tension tests, it does not perform well on the meat surface due to the lack of the ability to conform to the meat surface contours (results were very rough and dull). The film is too rigid and stands out on the surface making it unappealing. The 50% alginate/50% oxidized potato starch product also excels in purge control as well. These numbers are all higher than the control yields as seen in Table 1 by 2% or more which results in reduced purge.

In comparison, the 100% high viscosity alginate (Example 8) performed slightly worse in the purge control compared to Example 10. Although the differences in yield are slight, the 50% alginate/50% oxidized potato starch product is better due to the actual film evaluations. Specifically, the 100% alginate product produced a yellow color and clumps upon electrostatically coating. This leads to a rough coating with clumps of non-hydrated or non-set alginate. The alginate alone system does not adhere to the meat surface very well compared to systems with starch incorporated into them. This is especially true in comparison to highly oxidized starch systems. Moreover, the 100% alginate systems are cost prohibitive to meat producers.

Numerous modifications and variations in the practice of the invention are expected to occur to those skilled in the art upon consideration of the presently preferred embodiments thereof.

What is claimed is:

1. An electrostatic coating composition for food comprising a solids content of from 25% to 75% by weight gelatin and from 75% to 25% by weight oxidized starch.

2. The electrostatic coating composition of claim 1 comprising a solids content of from 40% to 60% by weight gelatin.

3. The electrostatic coating composition of claim 1 comprising a solids content of from 40% to 60% by weight oxidized starch.

4. The electrostatic coating composition of claim 1 wherein the oxidized starch is characterized by an oxidation level of from 4.5% to 5.5% calculated on a dry starch basis.

5. The electrostatic coating composition of claim 1 which further comprises an antibacterial agent.

6. A method of preparing a coated food product comprising applying by means of an electrostatic coating apparatus a coating composition comprising a solids content of from 25% to 75% by weight gelatin and from 25% to 75% by weight oxidized starch to said food product.

7. The method of claim 6 wherein the food product is a whole muscle food.

8. The method of claim 6 wherein the coating composition is applied at a coating level of 0.005% to 0.02% by weight.

9. The method of claim 6 wherein the coating composition comprises a solids content of from 40% to 60% by weight gelatin.

10. The method of claim 6 wherein the coating composition comprises from 40% 60% by weight oxidized starch.

11. The method of claim 6 wherein the oxidized starch is characterized by an oxidation level of from 4.5% to 5.5% calculated on a dry starch basis.

12. The method of claim 6 wherein an antibacterial agent is applied to the food product.

13. A coated food product produced according to the method of claim 6.

14. The coated food product of claim 13 which is a whole muscle tissue food product.

15. The coated food product of claim 13 which is a chicken breast.

16. An electrostatic coating composition for food comprising a solids content of from 25% to 75% by weight alginate and from 25% to 75% by weight starch.

17. The electrostatic coating composition of claim 16 comprising from 40% to 60% by weight alginate.

18. The electrostatic coating composition of claim 16 comprising from 40% to 60% by weight starch.

19. The electrostatic coating composition of claim 16 wherein the starch is an oxidized (5%) potato starch.

20. The electrostatic coating composition of claim 16 which further comprises an antibacterial agent.

21. A method of preparing a coated food product comprising applying by means of an electrostatic coating apparatus a coating composition comprising a solids content of from 25 to 75% by weight alginate and from 25% to 75% by weight starch to said food product.

22. The method of claim 21 wherein the food product is a whole muscle food.

23. The method of claim 21 wherein the coating composition is applied at a coating level of 0.005% to 0.02% by weight.

24. The method of claim 21 wherein the coating composition comprises from 40% to 60% by weight alginate.

25. The method of claim 21 wherein the coating composition comprises from 40% to 60% by weight starch.

26. The method of claim 21 wherein the oxidized starch is characterized by an oxidation level of from 4.5% to 5.5% calculated on a dry starch basis.

27. The method of claim 21 wherein an antibacterial agent is applied to the food product.

28. A coated food product produced according to the method of claim 21.

29. The coated food product of claim 28 which is a whole muscle food product.

30. The coated food product of claim 28 which is a chicken breast.
